(19) United States
(12) Patent Application Publication
(10) Pub. No.: US 2013/0038896 A1
(43) Pub. Date: Feb. 14, 2013

(54) DIRECT PRINTING FROM MOBILE DEVICES USING A NEAR FIELD COMMUNICATION (NFC) DEVICE

(71) Applicant: Jonathan David Nalewajek, Rochester, NY (US)

(72) Inventor: Jonathan David Nalewajek, Rochester, NY (US)

(73) Assignee: XEROX CORPORATION, Norwalk, CT (US)

(21) Appl. No.: 13/205,090

(22) Filed: Aug. 8, 2011

(51) Int. Cl. G06F 3/12

(52) U.S. Cl. 358/1.15

(57) ABSTRACT

In accordance with aspects of the present disclosure, a method, product, apparatus and system is disclosed. The method includes coupling a print device to a printer, wherein the print device comprises a memory arranged to store information including a printer driver associated with the printer; coupling a mobile device to the print device; receiving a document stored on the mobile device; converting the document to a format suitable to be printed by the printer using the print driver; and transmitting, by a transmitter, the document to the printer.

### DESCRIPTION OF THE DISCLOSURE

1. Field of the Disclosure

The present application is directed to direct printing from mobile devices using a near field communication (NFC) device.

2. Background of the Disclosure

Oftentimes, user of mobile devices would like to print documents from their devices without having to use another computer to connect with a printer. Conventionally, a user would have to send documents that the user would like to print to a device over a Wi-Fi connection using an internet protocol printing (IPP) or the RAW TCP/IP port on a printer. Typically, there are two ways available for the user to print in this manner. One way is the user to know the IP address of the printer and manually enter it into the mobile device's application. Another way is to scan the network for printers. Scanning the network for printers usually involves sending a multicast-DNS packet over the network, but in order for this packet to reach a printer so that the printer can respond and tell the mobile device that printing can occur, the mobile device (connected to the wireless network) and the printer must be on the same subnet. Often companies have multiple subnets, and the wireless connection may not be the same subnet that the printers are on. Current technologies used to discover devices on a network use multi-cast DNS packets (i.e., Bonjour, mDNS, etc.). In order to reach the device with the multi-cast packet, you can either need to be on the same subnet as the device, or the network administrator needs to configure the network in such a way that multi-cast packets are sent between subnets.

Moreover, certain devices only support specific formats such as postscript, PCL, PDF, etc. If a user sends the wrong format to a printer, this can result in a printer printing hundreds of pages of raw text, which is not ideal for large corporations with hundreds if not thousands of users printing. In one particular test, sending a one page document to a printer that did not support that file type caused the printer to print 300+pages of raw text.

Another conventional technique includes sending documents to a server which processes the file, converts it to the format supported by the printer, and then send this converted document from the server to the printer to print. This technique requires a server in order to process the files. This might not be an issue for large businesses that can afford to purchase and maintain a server, but for small to medium sized businesses that cannot afford such a server, a simpler and cheaper method is required. However, this conventional technique requires the printer to have a network connection.

Additionally, printing directly to a printer using Bluetooth requires that the printer be configured using Bluetooth. If the printer is not configured with Bluetooth, then printing cannot occur. Likewise, printing directly to a printer using Apple's AirPrint requires that that the user use an Apple device such as an Iphone or Ipad and requires that the printer support AirPrint. However, this method is limited to only users that have Apple devices, and only printers that support AirPrint.

### SUMMARY OF THE DISCLOSURE

In accordance with some aspects of the present disclosure, a method is disclosed. The method can include coupling a print device to a printer, wherein the print device comprises a memory arranged to store information including a printer driver associated with the printer; coupling a mobile device to the print device; receiving a document stored on the mobile device; converting the document to a format suitable to be printed by the printer using the print driver; and transmitting, by a transmitter, the document to the printer.

In some aspects, the method can also include connecting the print device to a computer to install the print driver for the printer in communication with the computer.

In some aspects, the coupling of the mobile device and the print device can comprise physically connecting the mobile device to the print device.

The mobile device can include mobile phones, smart phones and/or mobile computers.

The print device and the computer can be coupled through a physical connection or wireless technology. The physical connection can include a universal serial bus, serial port or parallel port. The print device and the mobile device can be coupled through near field communication technology.

In accordance with some aspects of the present disclosure, a device is disclosed. The device can include a print device configured to interface with a printer and a mobile device and to facilitate document printing. The print device can include a memory, in communication with a processor and arranged to store information including a print driver for the printer and documents to be printed by the printer; a first communication interface arranged to communicate with the mobile device to receive a document to be printed by the printer; the processor arranged to convert the document to format suitable to be printed by the printer based on the print driver; and a second communication interface arranged to communicate the converted document to the printer.

The print device can be arranged to be coupled to a computer to install the print driver for the printer in communication with the computer.

The mobile device and the printer hub can be arranged to be physically connected.

The mobile device can include mobile phones, smart phones and/or mobile computers.

The print device and the computer can be coupled through a physical connection or wireless technology. The physical connection can include a universal serial bus, serial port or parallel port.

In some aspects, the first interface can be arranged to include near field communication technology and the second interface can include a serial or a parallel computer interface.

In accordance with some aspects of the present disclosure, an article of manufacture is disclosed. The article can include a machine-readable medium that when executed by a controller cause the controller to receive a document from a mobile device; receive a print driver associated with a printer; convert the document to a format suitable to be printed by the printer using the print driver; and transmit, by a transmitter, the converted document to the printer to be printed.

Additional embodiments and advantages of the disclosure will be set forth in part in the description which follows, and can be learned by practice of the disclosure. The embodiments and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and, together with the description, serve to explain the principles of the disclosure.

### BRIEF DESCRIPTION OF THE DRAWINGS

FIG. 1 shows an example connection procedure of the print device and a computer in accordance with aspects of the present disclosure.

FIG. 2 shows an example connection procedure of the print device and a printer in accordance with aspects of the present disclosure.

FIG. 3 shows an example document print procedure in accordance with aspects of the present disclosure.

FIG. 4 shows an example mobile device process flow in accordance with aspects of the present disclosure.

FIG. 5 shows an example print device process flow in accordance with aspects of the present disclosure.

### DESCRIPTION OF THE EMBODIMENTS

Reference will now be made in detail to various exemplary embodiments of the present application, examples of which are illustrated in the accompanying drawings. Wherever possible, the same reference numbers will be used throughout the drawings to refer to the same or like parts.

In accordance with aspects of the present disclosure, a print device or “print pad,” is disclosed, which can provide a mobile device, such as a smart phone or handheld computing device, the ability to print documents stored on the mobile device on a printer. The print device allows one or more print drivers associated with one or more printers to be stored in a memory of the print device and allow users of the mobile device to select and transfers files or documents to the print device to be printed by the printer. The print device can be embodied as a small and portable USB device that contains a Near Field Communication (NFC) chip for communication with the mobile device. The print device can connect directly to a printer via a USB connection.

In general, a user with an NFC enabled device (smart phone, tablets, etc.) would set their device on the print pad which would activate the NFC interface. The user would then select a file to print, select print options, and then print the document. The document would first be transferred to the print pad, where it is converted to the appropriate format before being sent from the print pad to the printer.

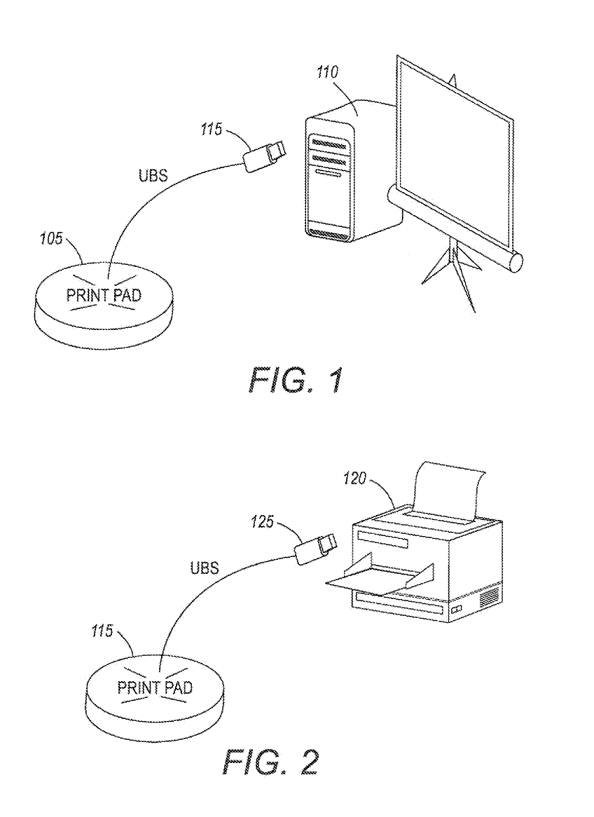

FIG. 1 shows an example connection procedure of the print device and a computer in accordance with aspects of the present disclosure. Print device 105 would first be connected to a PC 110 through a connection 115, for example, USB, and the administrator/user would install the drivers associated with the printer that the print pad will be connected to. For example, if the print pad will be connected to a Xerox WorkCentre 3550, the administrator/user would connect the print pad to their computer and install the WorkCentre 3550 drivers directly onto the print pad. These drivers would reside in the memory module located in the print pad. Once the drivers are installed on the print pad, the print pad is disconnected from the PC and is connected directly to the printer via USB.

Print device 105 can include a central processing unit used to process information sent from the user's device, a near field communication (NFC) interface used to communicate with the mobile device, a memory that stores driver data and any data needed during the document conversion process and a power supplied capable of providing sufficient power to the central processing unit. For example, the Near Field Communication interface can be embodied as a circuit or similar electronic component that allows for contactless communication between devices that are located very close to one another having a maximum separation distance around 20 cm.

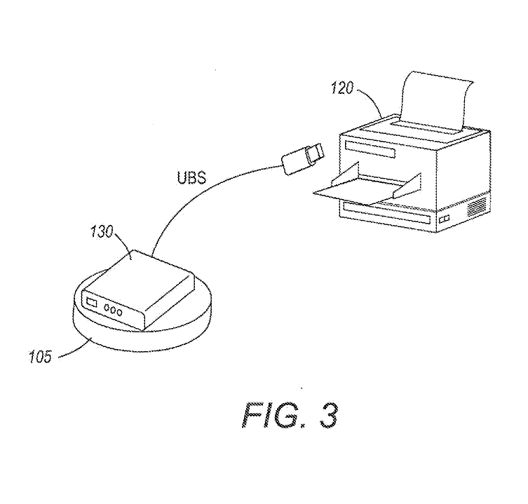

In some aspects, print device 105 and mobile device 130 (as described further below with respect to FIG. 3) both include NFC capability. When mobile device 130 is placed for example, on top or in within communication ranged of the NFC, of print pad 105, mobile device 130 can then communicate with print device 105 to transfer the file the user would like to print from their mobile device to print device 105.

FIG. 2 shows an example connection procedure of the print device and a printer in accordance with aspects of the present disclosure. Print device 105 is connected to printer 120 associated with the print drives loaded onto print device 105 through interface 125, for example, a USB interface.

FIG. 3 shows an example document print procedure in accordance with aspects of the present disclosure. Now, a mobile user that has mobile device 130, for example, an NFC enabled device can simply set their device on print device 105, select a file to print, select print options and print the document on printer 120. For example, when a user sets the NFC enabled device on the print pad, they will have to launch an application on the device that can communicate with the print pad. The launching of the application can be an automatic process if the application or another piece of software is able to recognize that the mobile device is mounted or coupled to the print device. This application would allow the user to select a file to print, select print options, and send the file to the print pad to convert.

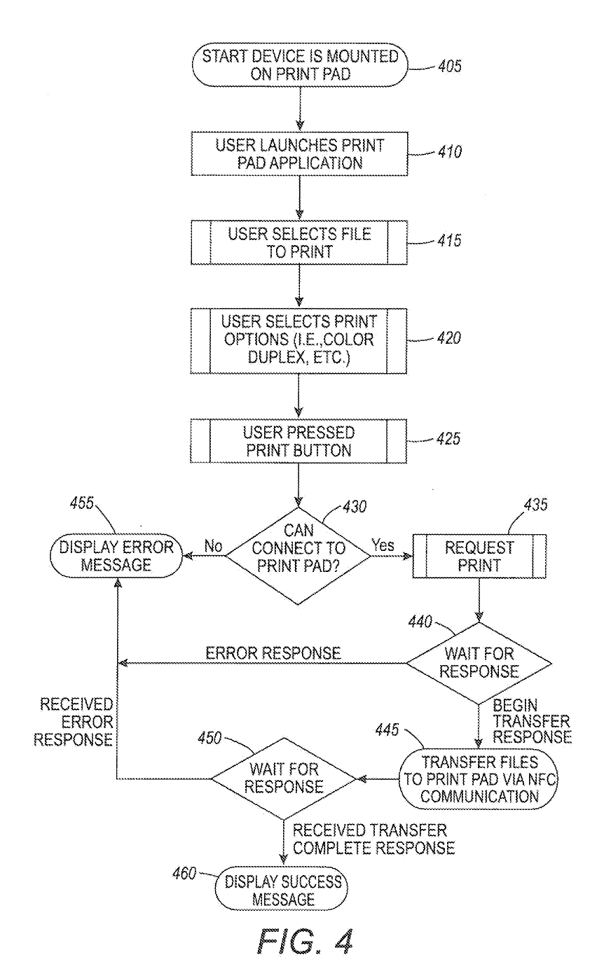

FIG. 4 shows an example mobile device process flow in accordance with aspects of the present disclosure. At 405, mobile device 130 is mounted on print device 105. At 410, a user launches a print pad application on mobile device 130. At 415, a user selects a file to print. At 420, a user selects print options (i.e., color, duplex, etc.). At 425, user presses “print” button. At 430, a determination is made as to whether the device can connect to print device 105. If the result of the determination at 435 is affirmative, then a print request is transmitted to print device 105 at 135. At 440, mobile device 130 waits for a response from print device 105. At 445, the file selected to be printed is transferred to print device 105 via NFC communication. At 450, a message to confirm receipt of the print request is transmitted to mobile device 130 from print device 105. If a response is not received at 450, an error response can be transmitted to mobile device 130 that indicates a problem with print request was encountered and displayed at 450. If the result of the determination at 430 is negative, an error message can be displayed at 450 on mobile device 130. If no error is encountered, a success message on mobile device 130 can be displayed at 460.

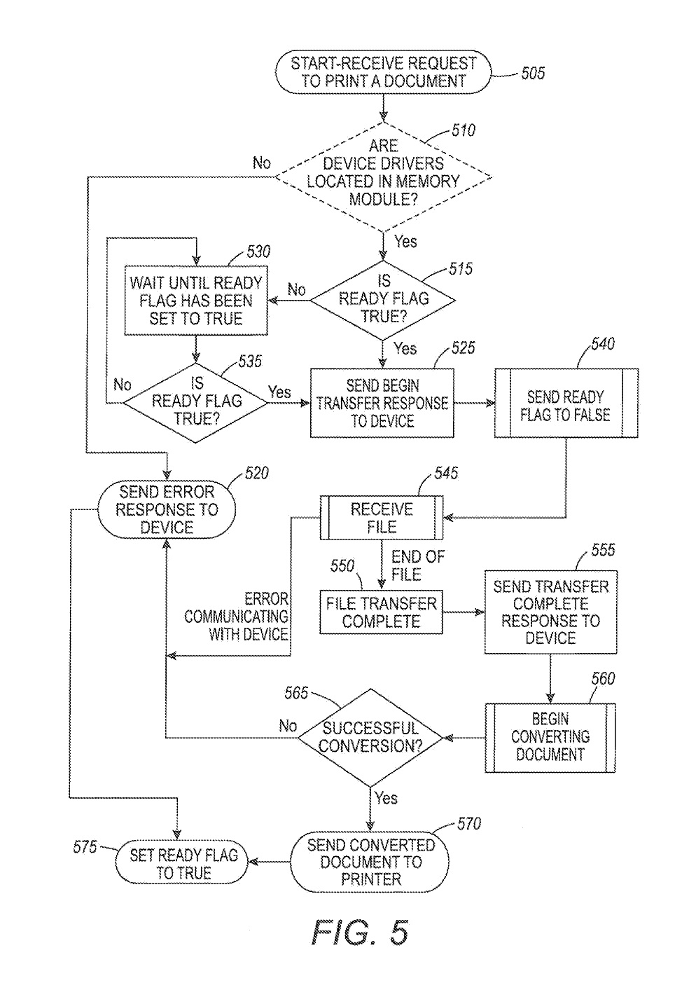

FIG. 5 shows an example workflow for the print device in accordance with aspects of the present disclosure. At 505, a request is received by print device 105 to print a document. At 510, a determination is made by print device 105 as to whether there are any device drivers located in the memory module. If the result of the determination at 510 is affirmative, then a determination is made at 515 as to whether a ready flag is true. If the result of the determination at 510 is negative, then an error response is sent to mobile device 130 at 520. If the result of the determination at 515 is affirmative, then a begin transfer response is sent at 525. If the result of the determination at 515 is negative, then print device 105 waits until a ready flag has been set to true at 530. After a predetermined time interval, another determination is made at 535 to check if the ready flag is true. If the result of the determination is negative at 535, then the print device 105 waits another predetermined time interval and goes back to 530. If the result of the determination at 535 is affirmative or the result of the determination at 515 is affirmative, then a begin transfer response message is sent to mobile device 130 at 525. At 540, a ready flag is sent to false. At 545, the file sent by mobile device 130 is received at print device 105. At 550, the file transfer is completed and a file transfer message is transmitted to mobile device 130 indicating that the file transfer is complete at 555. At 560, the file is converted to an appropriate format for printing based on the print driver. At 565, a determination is made by print device 105 as to whether the file conversion is successful. If the result of the determination at 565 is affirmative, then the converted file is sent to the printer at 570. If the result of the determination at 565 is negative, then an error message is sent to mobile device 130 at 520 and a ready flag is set to true at 575.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “an acid” includes two or more different acids. As used herein, the term “include” and its grammatical variants are intended to be non-limiting, such that recitation of items in a list is not to the exclusion of other like items that can be substituted or added to the listed items.

It should be appreciated that the decision as to whether the various parts of the controller are implemented in hardware (e.g. as a hard-wired circuit and/or as a circuit configuration fabricated into an application-specific integrated circuit) and/or software (e.g. machine-readable code, such code being instructions executable by an array of logic elements such as a microprocessor or other digital signal processing unit), and as to whether the state register and task database are stored in the same or separate storage devices (e.g. one or more semiconductor or ferroelectric memory units or magnetic or phase-change media such as disks (floppy, hard, CD, DVD, ROM or RAM)), is a matter of convenience in a particular embodiment of the invention. Also, the operations of constructing possible sequences of tasks and then selecting a sequence may be conducted sequentially, that is a plurality of sequences are generated and then searched for one meeting the relevant criteria, or in parallel, e.g. each sequence generated is tested against the relevant criteria as it is generated. In the latter approach, the generation of possible sequences may be halted as soon as a match is found or continued, if there is still the possibility of generating other possible sequences, to find multiple solutions which may then be selected from.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages, may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives; modifications variations,, improvements, and substantial equivalents.

What is claimed is:

1. A method comprising:
coupling a print device to a printer, wherein the print device comprises a memory arranged to store information including a printer driver associated with the printer;
coupling a mobile device to the print device;
receiving a document stored on the mobile device;
converting the document to a format suitable to be printed by the printer using the print driver; and
transmitting, by a transmitter, the converted document to the printer.

2. The method according to claim 1, further comprising connecting the print device to a computer to install the print driver for the printer in communication with the computer.

3. The method according to claim 1, wherein the coupling of the mobile device and the print device comprises physically connecting the mobile device to the print device:

4. The method according to claim 1, wherein the mobile device is selected from the group consisting of a mobile phone, a mobile computer and combinations thereof.

5. The method according to claim 1, wherein the print device and the computer are coupled through a physical connection or wireless technology.

6. The method according to claim 5, wherein the physical connection comprises a universal serial bus, serial port or parallel port.

7. The method according to claim 1, wherein the print device and the mobile device are coupled through near field communication technology.

8. A device comprising:
a print device configured to interface with a printer and a mobile device and to facilitate document printing, the print device comprising:
a memory, in communication with a processor and arranged to store information including a print driver for the printer and documents to be printed by the printer;
a first communication interface arranged to communicate with the mobile device to receive a document to be printed by the printer;
the processor arranged to convert the document to format suitable to be printed by the printer based on the print driver; and
a second communication interface arranged to communicate the converted document to the printer.

9. The device according to claim 8, wherein the print device is arranged to be coupled to a computer to install the print driver for the printer in communication with the computer.

10. The device according to claim 8, wherein the mobile device and the printer hub are arranged to be physically connected.

11. The device according to claim 8, wherein the mobile device'is selected from the group consisting of a mobile phone, a mobile computer and combinations thereof:

12. The device according to claim 9, wherein the print device and the computer are coupled through a physical connection or wireless technology.

13. The device according to claim 12, wherein the physical connection comprises a universal serial bus, serial port or parallel port

14. The device according to claim 12, wherein the first interface is arranged to include near field communication technology.

15. The device according to claim 12, wherein the second interface includes a serial or a parallel computer interface.

16. An article of manufacture comprising:
a machine-readable medium that when executed by a controller cause the controller to:
receive a document from a mobile device;
receive a print driver associated with a printer;
convert the document to a format suitable to be printed by the printer using the print driver; and
transmit, by a transmitter, the converted document to the printer to be printed.
